(19) United States
(12) Patent Application Publication
(10) Pub. No.: US 2015/0224749 A1
(43) Pub. Date: Aug. 13, 2015

(54) COVER MATERIAL

(71) Applicant: TOPPAN PRINTING CO., LTD., Tokyo (JP)

(72) Inventor: Masanobu Yoshinaga, Tokyo (JP)

(73) Assignee: TOPPAN PRINTING CO., LTD., Tokyo (JP)

(21) Appl. No.: 14/430,761

(22) PCT Filed: Sep. 27, 2012
(86) PCT No.: PCT/JP2012/006172

§ 371 Date: Mar. 24, 2015

(30) Foreign Application Priority Data
Sep. 25, 2012 (JP) 2012-211487

(51) Int. Cl. B32B 27/08; B32B 27/32; B32B 15/08; B32B 27/30; B32B 7/12; B32B 29/00

(52) U.S. Cl. CPC B32B 27/08; B32B 7/12; B32B 29/002; B32B 15/08; B32B 27/30; B32B 27/32; B32B 2255/12; B32B 2270/00; B32B 2435/02

(57) ABSTRACT

A cover material used for a container has a seal part covered with a polyethylene resin. The cover material includes a base material and a sealant layer. The sealant layer has a laminated structure obtained through lamination of a first thermoplastic resin layer, adhesive to the base material, and a second thermoplastic resin layer, adhesive to the seal part covered with the polyethylene resin. Thicknesses of the first thermoplastic resin layer and the second thermoplastic resin layer satisfy: thickness of first thermoplastic resin layer≦thickness of second thermoplastic resin layer. The layer of the second thermoplastic resin has a dispersion structure obtained by dispersing, in the first thermoplastic resin, the second thermoplastic resin that is non- compatible or partially compatible to the first thermoplastic resin such that a ratio Us of a domain longer diameter 1 and a domain shorter diameter s of the second thermoplastic resin is within 1.5≦l/s≦10.

### CROSS REFERENCE TO RELATED APPLICATIONS

This application is a U.S. National Stage Application, which claims the benefit under 35 U.S.C. § 371, of PCT International Patent Application No. PCT/JP2012/006172, filed Sep. 27, 2012, which is based on and claims the foreign priority benefit of Japanese Patent Application No. 2012-211487, filed Sep. 25, 2012, the entire disclosures of which are herein incorporated by reference as a part of this application.

### TECHNICAL FIELD

The present invention relates to a cover material used for a container having a seal part covered with polyethylene.

### BACKGROUND ART

In the field of food packaging, increased usage has been observed for modes of packaging such as cups and trays filled with contents such as instant noodles, jelly, or yogurt. Such cups or trays are generally manufactured using a method such as injection molding or vacuum compression molding a thermoplastic resin such as polystyrene, expanded polystyrene, and polypropylene resins. However, in recent years, in consideration of resource saving, waste volume reduction, and recycling efficiency; paper cups obtained by laminating a polyolefin resin such as a polyethylene resin on paper have been developed, and are filled with contents such as not only instant noodles but also beverages, etc.

With regard to the qualities required for a cover material used in a cup container, a sealant layer which is the innermost layer of the cover material for protecting a content is preferably strongly adhered to the container such as a cup, which is an adherent. On the other hand, an opposite quality of being easily unsealable only upon unsealing is demanded.

In order to satisfy the required qualities described above, various functions have been added to the cover material. One of such functions involves a design of an easily unsealable mechanism. Examples of the easily unsealable mechanism include an inter-layer peeling mechanism and a cohesion peeling mechanism. Among these, the cohesion peeling mechanism is designed by blending, in the thermoplastic resin, a non-compatible type or a partially compatible type thermoplastic resin. The peeling principle behind the cohesion peeling mechanism relates to making use of the small cohesive force of the non-compatible type or the partially compatible type thermoplastic resin blend layer and utilizing a cohesion failure in the non-compatible type or the partially compatible type thermoplastic resin blend layer, instead of rupturing at an interface between the adherent and the sealant at the innermost part of the cover material upon unsealing.

Problems of the cohesion peeling mechanism described above include occurrence of stringiness upon unsealing. Occurrence of stringiness is suppressed by reducing layer thickness of an easily unsealable layer (thermoplastic resin blend layer) as much as possible. Alternatively, since the easily unsealable layer generally forms a sea-island structure in which a fine spherical domain phase is dispersed in a matrix phase, it is also possible to suppress stringiness through morphological designing such as reducing the dispersion diameter of the domain phase as much as possible. However, thinly forming the thermoplastic resin blend layer is an extremely difficult technology in terms of film thickness control, resulting in deteriorated processability. Furthermore, since finely dispersing the domain phase significantly improves interface adhesiveness of two members, unsealing strength becomes strong and it is difficult to provide the ease of unsealing.

### CITATION LIST

### Patent Literature

[PTL 1] Japanese Laid-Open Patent Publication No. 2005-335818 (Application No. 2005-245399)

### SUMMARY OF THE INVENTION

### Problems to be Solved by the Invention

An objective of the present invention is to provide a cover material that can reduce occurrence of stringiness upon unsealing without compromising the ease of unsealing.

### Solutions to the Problems

A cover material used for a container has a seal part covered with a polyethylene resin. The cover material includes a base material and a sealant layer. The sealant layer has a laminated structure obtained through lamination of a layer of a first thermoplastic resin having adhesiveness with respect to the base material, and a layer of a second thermoplastic resin having adhesiveness with respect to the seal part. Thicknesses of the layer of the first thermoplastic resin and the layer of the second thermoplastic resin satisfy: a thickness of the layer of the first thermoplastic resin≦a thickness of the layer of the second thermoplastic resin. The layer of the second thermoplastic resin has a dispersion structure obtained by dispersing, in the first thermoplastic resin, the second thermoplastic resin that is non-compatible or partially compatible with respect to the first thermoplastic resin such that a ratio l/s of a domain longer diameter l and a domain shorter diameter s of the second thermoplastic resin falls in a range of 1.5≦l/s≦10.

### Advantageous Effects of the Invention

With the present invention, it is possible to provide a cover material that is superior in terms of the ease of unsealing and can reduce occurrence of stringiness upon unsealing.

### BRIEF DESCRIPTION OF THE DRAWINGS

FIG. 1 is a cross-sectional schematic diagram showing one example of a layer configuration of a cover material according to the present invention.

FIG. 2A shows a state in which a domain of a second thermoplastic resin is dispersed in an elliptical shape or a flat shape.

FIG. 2B shows a state in which the domain of the second thermoplastic resin is dispersed perfectly spherically.

FIG. 3 is a cross-sectional schematic diagram showing a layer configuration of a cover material according to Example 1.

FIG. 4 is a cross-sectional schematic diagram showing a layer configuration of a cover material according to Example 2.

FIG. 5 is a cross-sectional schematic diagram showing a layer configuration of a cover material according to Example 3.

FIG. 6 is a cross-sectional schematic diagram showing a layer configuration of a cover material according to Example 4.

FIG. 7 is a cross-sectional schematic diagram showing a layer configuration of a cover material according to Example 5.

FIG. 8 is a cross-sectional schematic diagram showing a layer configuration of a cover material according to Comparative Example 1.

FIG. 9 is a cross-sectional schematic diagram showing a layer configuration of a cover material according to Comparative Example 2.

### DESCRIPTION OF EMBODIMENTS

FIG. 1 is a cross-sectional schematic diagram showing one example of a layer configuration of a cover material 1 according to the present invention. As shown in FIG. 1, the cover material 1 is formed by laminating a sealant layer 7 on a surface on one side of a base material 2.

For example, the base material 2 includes a paper layer 4, a printing ink layer 3 formed by printing on a surface on one side of the paper layer 4, and a metallic foil layer 6 laminated on the other surface of the paper layer 4 via an adhesion resin layer 5. As the adhesion resin layer 5, for example, polyethylene resins, and acid copolymers such as ethylene—acrylic acid copolymer resins and ethylene—methacrylic acid copolymer resins can be used. As the metallic foil layer 6, an aluminium foil can be suitably used. The layer configuration of the base material 2 is not limited to the configuration described above, and may be a configuration obtained by, for example, laminating two layers, a paper layer and a PET layer having provided thereon light-blocking printing. If necessary, an adhesive layer may also be laminated. Furthermore, the material of paper for the paper layer is not particularly limited.

The sealant layer 7 includes a first thermoplastic resin layer 8 formed on a base material side and a second thermoplastic resin layer 11 disposed on the outermost surface. The sealant layer 7 is formed by co-extruding a forming material of the first thermoplastic resin layer 8 and a forming material of the second thermoplastic resin layer 11 on a surface on one side of the base material 2. In order to ensure adhesion between the base material 2 and the sealant layer 7, an anchor coating layer 12 may be disposed on the surface on one side of the base material 2 if necessary. The thicknesses of the first thermoplastic resin layer 8 and the second thermoplastic resin layer 11 are set so as to satisfy: thickness of the first thermoplastic resin layer 8≦thickness of the second thermoplastic resin layer. When the thickness of the second thermoplastic resin layer 11 is smaller than the thickness of the first thermoplastic resin layer 8, the first thermoplastic resin layer 8 is exposed to a heat-seal surface, and thereby adhesion becomes inhibited. In terms of adhesive strength and cost, the thicknesses of the first thermoplastic resin layer 8 and the second thermoplastic resin layer 11 are preferable equal.

As the first thermoplastic resin layer 8, a layer that can be used is formed from, for example, at least one type of resin such as ethylene—acrylic acid copolymer resins, ethylene—methacrylic acid copolymer resins, ethylene—acrylic acid—acrylic acid ester terpolymer resins, ethylene—methacrylic acid—acrylic acid ester terpolymer resins, ethylene—acrylic acid—methacrylic acid ester terpolymer resins, ethylene—methacrylic acid—methacrylic acid ester terpolymer resins, ethylene—acrylic acid ester—acid anhydride (such as maleic anhydride) terpolymer resins, and ethylene—methacrylic acid ester—acid anhydride (such as maleic anhydride) terpolymer resins.

The second thermoplastic resin layer 11 is a resin layer obtained by blending a first thermoplastic resin 9 and a second thermoplastic resin 10. In the cover material 1, when cohesion peeling is to be employed as the unsealing mechanism, the second thermoplastic resin 10 that is to be blended in the second thermoplastic resin layer 11 is a resin that is completely non-compatible or partially compatible with respect to the first thermoplastic resin 9. Furthermore, in the present invention, when an adherence surface of a container such as a cup is covered with a polyethylene resin, a combination of low density polyethylene/polybutene-1 is preferable as the combination of the first thermoplastic resin 9/the second thermoplastic resin 10. As the low density polyethylene used as the first thermoplastic resin 9, one having a melting point of 100° C. to 115° C. and a melt flow rate (MFR) in a range of 15 to 40 g/10 min is preferably used. Furthermore, as the polybutene-1 used as the second thermoplastic resin 10, one having a melting point of 125° C., a density of 0.905 to 0.917 g/cm³, and an MFR of 1 to 20 is preferably used.

The blend ratio of the first thermoplastic resin 9 and the second thermoplastic resin 10 is preferably in a range of 60 to 80 wt % for the first thermoplastic resin 9 and 20 to 40 wt % for the second thermoplastic resin 10. When the blend ratio of the second thermoplastic resin 10 is lower than 20 wt %, the seal strength becomes too strong; whereas when the blend ratio is higher than 40 wt %, stringiness occurs easily upon unsealing.

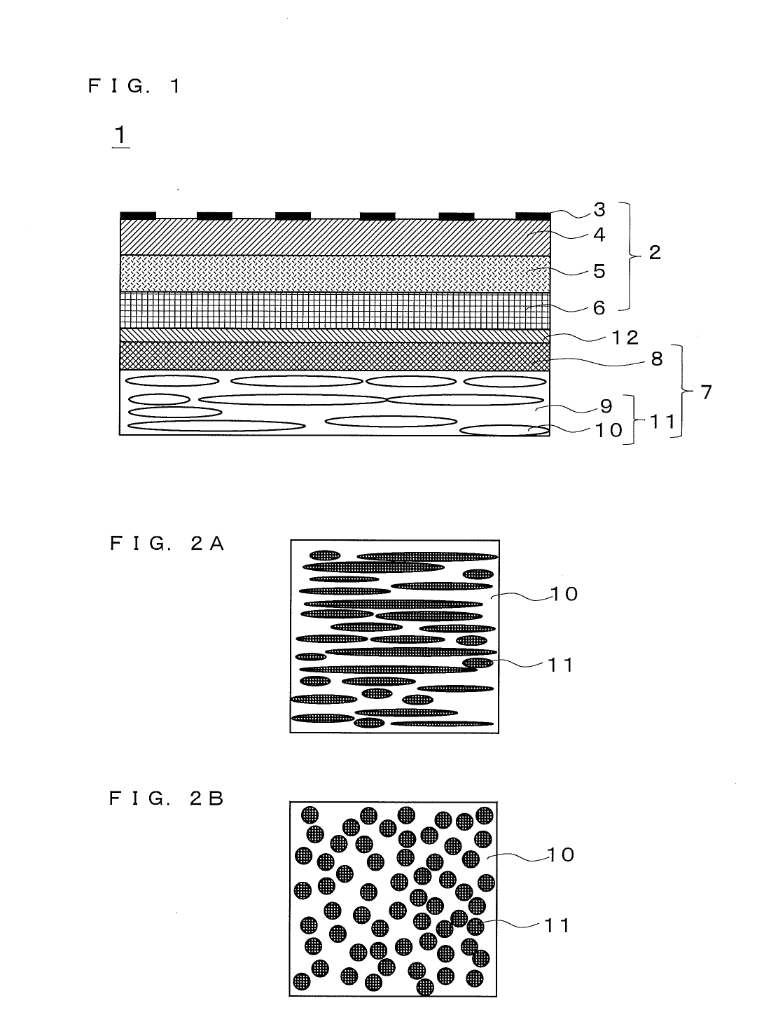

As the morphology of the second thermoplastic resin layer 11, a domain diameter l/s (l: longer diameter of a domain, s: shorter diameter of a domain) of the second thermoplastic resin 10 dispersed in the first thermoplastic resin 9 which forms the base is preferably within a range of 1.5≦l/s≦10. In the second thermoplastic resin 10, when the second thermoplastic resin 10 whose domain diameter falls within the above described range is contained by 50% or more in the whole, the ease of unsealing becomes excellent and reduction in occurrence of stringiness can be achieved. When the second thermoplastic resin 10 has a domain diameter l/s within the above described range and is dispersed in an elliptical shape or flat shape as shown in FIG. 2A; the size of the area at which a matrix phase breaks upon unsealing can be reduced and the strength required upon unsealing can be suppressed when compared to a case where the second thermoplastic resin 10 is dispersed in a perfectly spherical manner (l/s=1) as shown in FIG. 2B. When the domain diameter of the second thermoplastic resin 10 is in a range of l/s>10, extension of the second thermoplastic resin 10 upon unsealing of the cover material 1 occurs, which possibly causes stringiness. The second thermoplastic resin 10 has a domain diameter l/s in a range of 1.5≦l/s≦10. Further preferably, as described in the following, the first thermoplastic resin 9 is set to have resin physical properties of a tensile breaking strength of 5 to 20 MPa and a tensile break elongation of not larger than 600% in accordance with JIS.K7113. By setting the resin physical properties of the first thermoplastic resin 9 in the above described ranges, it is possible to obtain a synergy between an advantageous effect of reducing the breaking area in the matrix phase and an advantageous effect of resolving stringiness.

In order to form the morphology described above, it is necessary to adjust the MFR ratio of the first thermoplastic resin 9 and the second thermoplastic resin 10 at 190° C. and 21.168 N based on JIS.K7210, or melt viscosity ratio therebetween at an actual processing temperature and shear rate range. However, in general, when the viscosity of the second thermoplastic resin 10 is higher than the viscosity of the first thermoplastic resin 9 under molding-processing temperature and shear rate, the above described morphology can be formed. Thus, there would be no problems if the melt viscosity of the first thermoplastic resin 9 is smaller than the melt viscosity of the second thermoplastic resin 10 at a membrane formation condition. In particular, a larger difference in melt viscosities of the first thermoplastic resin 9 and the second thermoplastic resin 10 is preferable since the second thermoplastic resin 10 will be dispersed in an elliptical shape or a flat shape. Thus, the MFR ratio of the first thermoplastic resin 9 and the second thermoplastic resin 10 is preferably 1/40 to 3/4, and further preferably 9/175 to 9/100.

As described above, the first thermoplastic resin 9 preferably has a tensile breaking strength of 5 to 20 MPa and a tensile break elongation of not larger than 600% in accordance with JIS.K7113. Here, the measurement test pieces and measuring conditions for the tensile break elongation and tensile breaking strength in accordance with JIS.K7113 are in conformance with JIS.K7113. For example, when a resin that is to be measured is a low density polyethylene resin, the test is performed with a No. 2 test piece having a thickness of 2.0±0.2 mm under a condition of testing rate of 200 mm/min.

When the tensile breaking strength of the first thermoplastic resin 9 is smaller than 5 MPa, the strength thereof becomes too low as a resin, and a seal strength may not be obtained. Furthermore, when the first thermoplastic resin 9 has a tensile breaking strength that is larger than 20 MPa and a tensile break elongation that is larger than 600%, stringiness may occur upon unsealing. Thus, a tensile breaking strength of 5 to 20 MPa and a tensile break elongation not larger than 600% are preferable.

An unsealing strength between the cover material 1 and the container is preferably 1 to 15 N/15 mm when the ease of unsealing is considered. The adhesive strength becomes inferior when the unsealing strength is smaller than 1 N/15 mm, and the ease of unsealing becomes inferior when the unsealing strength is larger than 15 N/15 mm.

### EXAMPLES

In the following, although the present invention will be described in further detail through the following Examples, the present invention is not limited only to these Examples.

### Example 1

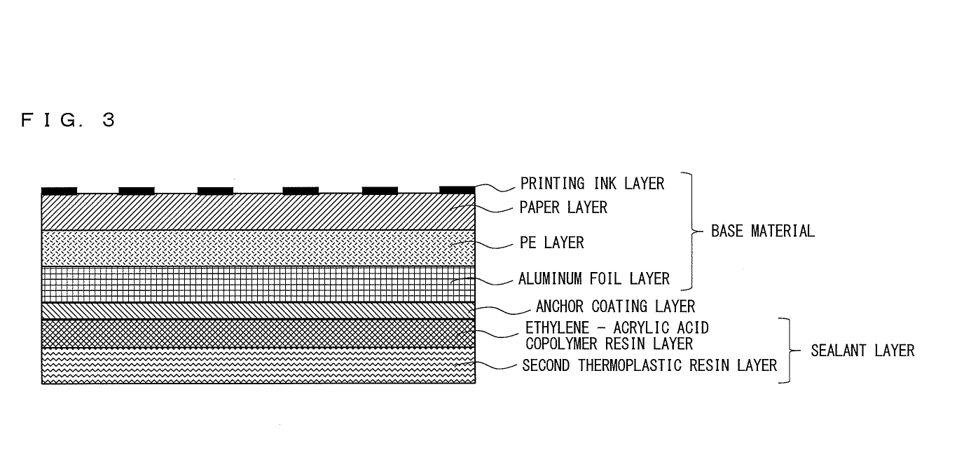

FIG. 3 is a cross-sectional schematic diagram showing a layer configuration of a cover material according to Example 1.

Base Material

A base material having a layer configuration of printing ink layer/paper layer/polyethylene layer/aluminum foil layer was used.

Formation of Sealant Layer

As a forming material of the first thermoplastic resin layer, an ethylene—acrylic acid copolymer was used; and, as a forming material of the second thermoplastic resin layer, a blend resin obtained by mixing a low density polyethylene (melting point: 105° C., MFR: 25 g/10 min) and a polybutene-1 (melting point: 125° C., MFR: 1.8 g/10 min) respectively at a weight ratio of 70 wt % and 30 wt % was used. An anchor coating layer was disposed on an aluminium foil of the base material, and the forming material of the first thermoplastic resin layer and the forming material of the second thermoplastic resin layer were co-extruded to form a sealant layer. The film thickness of the first thermoplastic resin layer and the film thickness of the second thermoplastic resin layer were both set to 15 μm.

### Example 2

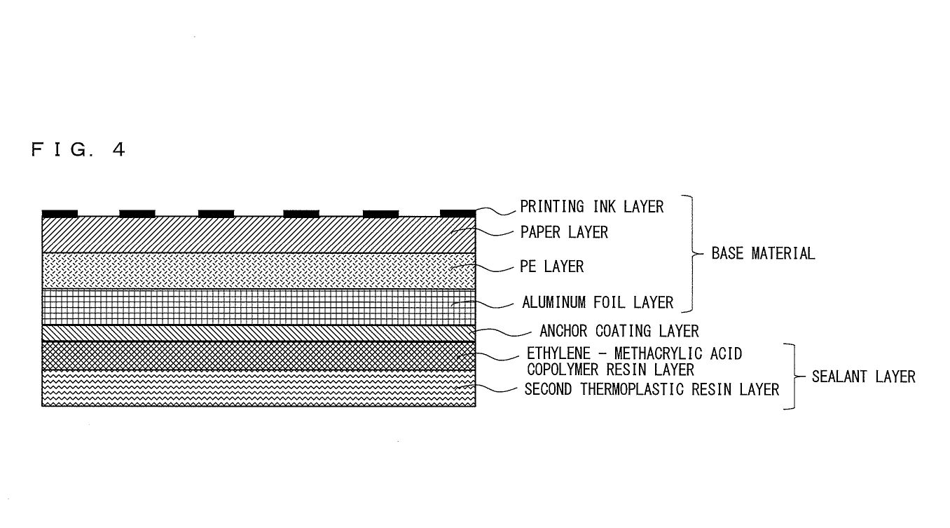

FIG. 4 is a cross-sectional schematic diagram showing a layer configuration of a cover material according to Example 2.

Base Material

A base material similar to that in Example 1 was used.

Formation of Sealant Layer

As a forming material of the first thermoplastic resin layer, an ethylene—methacrylic acid copolymer was used; and, as a forming material of the second thermoplastic resin layer, a blend resin obtained by mixing a low density polyethylene (melting point: 100° C., MFR: 20 g/10 min) and a polybutene-1 (melting point: 125° C., MFR: 1.8 g/10 min) respectively at a weight ratio of 80 wt % and 20 wt % was used. An anchor coating layer was disposed on an aluminium foil of the base material, and the forming material of the first thermoplastic resin layer and the forming material of the second thermoplastic resin layer were co-extruded to form a sealant layer. The film thickness of the first thermoplastic resin layer and the film thickness of the second thermoplastic resin layer were both set to 15 μm.

### Example 3

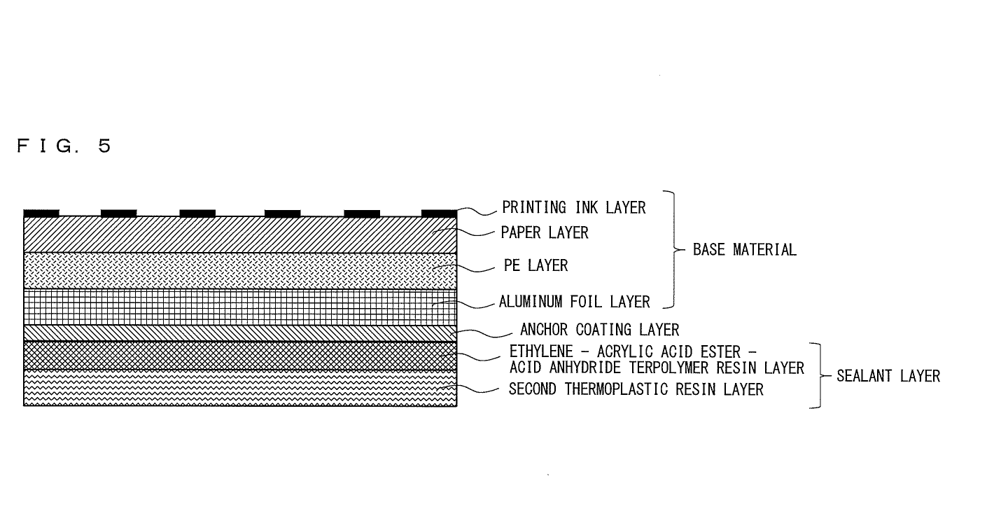

FIG. 5 is a cross-sectional schematic diagram showing a layer configuration of a cover material according to Example 3.

Base Material

A base material similar to that in Example 1 was used.

Formation of Sealant Layer

As a forming material of the first thermoplastic resin layer, an ethylene—acrylic acid ester—acid anhydride ternary copolymer was used; and, as a forming material of the second thermoplastic resin layer, a blend resin obtained by mixing a low density polyethylene (melting point: 115° C., MFR: 35 g/10 min) and a polybutene-1 (melting point: 125° C., MFR: 1.8 g/10 min) respectively at a weight ratio of 60 wt % and 40 wt % was used. An anchor coating layer was disposed on an aluminium foil of the base material, and the forming material of the first thermoplastic resin layer and the forming material of the second thermoplastic resin layer were co-extruded to form a sealant layer. The film thickness of the first thermoplastic resin layer was set to 5 μm, and the film thickness of the second thermoplastic resin layer was set to 15 μm.

### Example 4

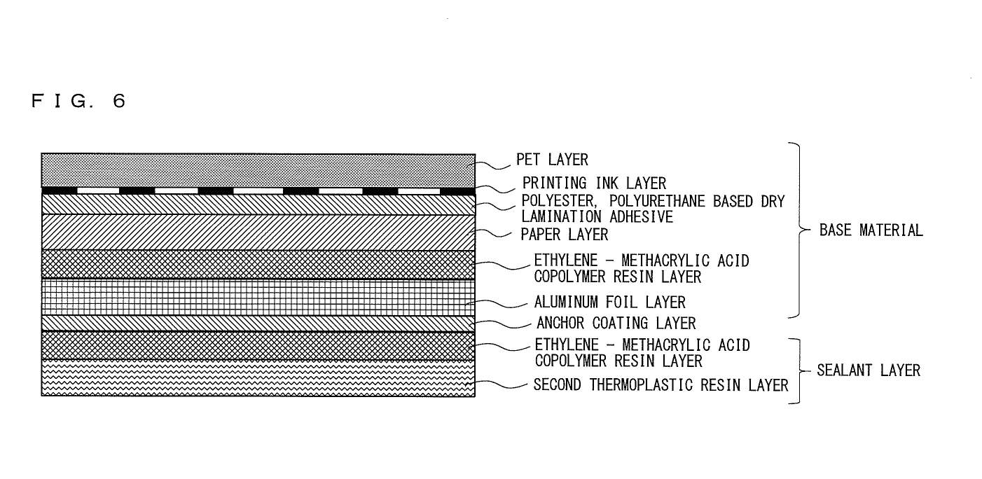

FIG. 6 is a cross-sectional schematic diagram showing a layer configuration of a cover material according to Example 4.

Base Material

The base material that was used had a layer configuration of PET layer/printing ink layer/paper layer/ethylene—methacrylic acid copolymer resin layer/aluminum foil layer; and the paper layer and the PET layer having the printing ink layer disposed thereon were laminated via a polyester, polyurethane based dry lamination adhesive.

Formation of Sealant Layer

As a forming material of the first thermoplastic resin layer, an ethylene—methacrylic acid copolymer was used; and, as a forming material of the second thermoplastic resin layer, a blend resin obtained by mixing a low density polyethylene (melting point: 105° C., MFR: 25 g/10 min) and a polybutene-1 (melting point: 125° C., MFR: 1.8 g/10 min) respectively at a weight ratio of 70 wt % and 30 wt % was used. An anchor coating layer was disposed on an aluminium foil of the base material, and the forming material of the first thermoplastic resin layer and the forming material of the second thermoplastic resin layer were co-extruded to form a sealant layer. The film thickness of the first thermoplastic resin layer and the film thickness of the second thermoplastic resin layer were both set to 10 μm.

### Example 5

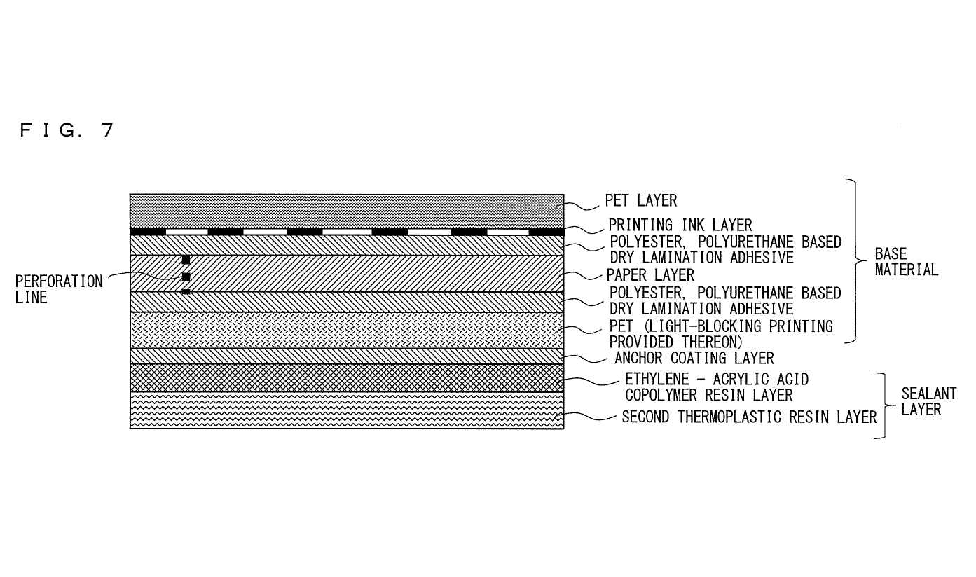

FIG. 7 is a cross-sectional schematic diagram showing a layer configuration of a cover material according to Example 5.

Base Material

A base material that was used had a layer configuration of PET layer/printing ink layer/paper layer/PET layer having provided thereon light-blocking printing, and was obtained by laminating a PET layer having disposed thereon the printing ink layer and the paper layer, and a PET layer having provided thereon the light-blocking printing and a paper layer via the polyester, polyurethane based dry lamination adhesive. In addition, on the paper layer, a perforation line for enabling partial detachment between the paper layer and the PET layer thereabove was formed.

Formation of Sealant Layer

As a forming material of the first thermoplastic resin layer, an ethylene—acrylic acid copolymer was used; and, as a forming material of the second thermoplastic resin layer, a blend resin obtained by mixing a low density polyethylene (melting point: 105° C., MFR: 25 g/10 min) and a polybutene-1 (melting point: 125° C., MFR: 1.8 g/10 min) respectively at a weight ratio of 70 wt % and 30 wt % was used. An anchor coating layer was disposed on the PET layer having provided thereon light-blocking printing of the base material, and the forming material of the first thermoplastic resin layer and the forming material of the second thermoplastic resin layer were co-extruded to form a sealant layer. The film thickness of the first thermoplastic resin layer and the film thickness of the second thermoplastic resin layer were both set to 10 μm.

### Comparative Example 1

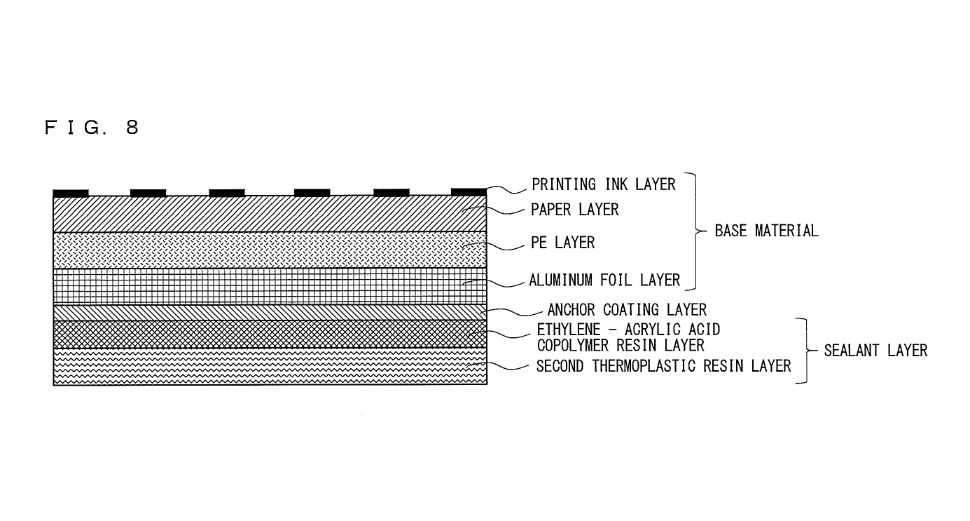

FIG. 8 is a cross-sectional schematic diagram showing a layer configuration of a cover material according to Comparative Example 1.

Base Material

A base material similar to that in Example 1 was used.

Formation of Sealant Layer

As a forming material of the first thermoplastic resin layer, an ethylene—acrylic acid copolymer was used; and, as a forming material of the second thermoplastic resin layer, a blend resin obtained by mixing a low density polyethylene (melting point: 105° C., MFR: 10 g/10 min) and a polybutene-1 (melting point: 125° C., MFR: 1.8 g/10 min) respectively at a weight ratio of 90 wt % and 10 wt % was used. An anchor coating layer was disposed on an aluminium foil of the base material, and the forming material of the first thermoplastic resin layer and the forming material of the second thermoplastic resin layer were co-extruded to form a sealant layer. The film thickness of the first thermoplastic resin layer and the film thickness of the second thermoplastic resin layer were both set to 15 μm.

### Comparative Example 2

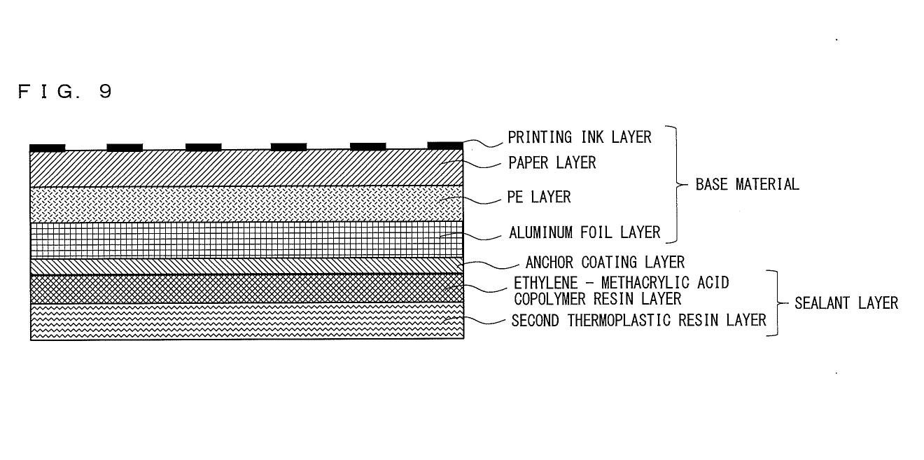

FIG. 9 is a cross-sectional schematic diagram showing a layer configuration of a cover material according to Comparative Example 2.

Base Material

A base material similar to that in Example 1 was used.

Formation of Sealant Layer

As a forming material of the first thermoplastic resin layer, an ethylene—methacrylic acid copolymer was used; and, as a forming material of the second thermoplastic resin layer, a blend resin obtained by mixing a low density polyethylene (melting point: 120° C., MFR: 20 g/10 min) and a polybutene-1 (melting point: 125° C., MFR: 1.8 g/10 min) respectively at a weight ratio of 50 wt % and 50 wt % was used. An anchor coating layer was disposed on an aluminium foil of the base material, and the forming material of the first thermoplastic resin layer and the forming material of the second thermoplastic resin layer were co-extruded to form a sealant layer. The film thickness of the first thermoplastic resin layer and the film thickness of the second thermoplastic resin layer were both set to 15 μm.

The following measurements and evaluations were performed using the cover materials having the layer configurations shown in FIGS. 3 to 9 obtained from Examples 1 to 5 and Comparative Examples 1 and 2.

Measurement of Seal Strength

The cover materials obtained above were heat-sealed at 130 to 160° C. to a container having a seal part covered with a polyethylene resin, and heat-seal strengths were measured. The seal pressure was set to 0.15 MPa and the sealing time was set to 1 second. By using the container heat-sealed with each of the cover materials, a 90-degree peel test was performed and the seal strength was measured.

Evaluation of Stringiness on Peel Surface

Using a container heat-sealed with each of the cover materials in a manner similar to the measurement of the seal strength, stringiness of a peel surface was visually evaluated by unsealing the cover material by hand.

Evaluation of Sensation Upon Unsealing

Using a container heat-sealed with each of the cover materials in a manner similar to the measurement of the seal strength, the sensation upon unsealing was evaluated when the cover material was unsealed by hand.

Table 1 shows the measurement results of seal strength, and the evaluation results of stringiness of a peel surface and the sensation upon unsealing.

TABLE 1

| | Seal | Stringiness of | Sensation Upon |
|---|---|---|---|
| | Strength | Peel Surface | Unsealing |
| Example 1 | Δ | ∘ | Δ |
| Example 2 | ∘ | ∘ | ∘ |
| Example 3 | Δ | Δ | ∘ |
| Example 4 | Δ | ∘ | ∘ |
| Example 5 | Δ | ∘ | ∘ |
| Comparative Example 1 | x | ∘ | x |
| Comparative Example 2 | x | x | x |

∘: Excellent
Δ: Slightly good
x: Inferior

From Table 1, when compared to the cover materials obtained in Comparative Examples 1 and 2; the cover materials obtained in Examples 1 to 5 had shown a satisfactory strong adhesion between the cover material and the container, and were each confirmed to be a cover material providing the ease of unsealing. Furthermore, the cover materials obtained in Examples 1 to 5 also enabled reduction in occurrence of stringiness upon unsealing, and were confirmed to be excellent also for the sensation upon unsealing.

### INDUSTRIAL APPLICABILITY

The present invention is useful as a cover material used for a container having a seal part covered with polyethylene.

### Description of the Reference Characters

1 cover material
2 base material
3 printing ink layer
4 paper layer
5 adhesion resin layer
6 metallic foil layer
7 sealant layer
8 first thermoplastic resin layer
9 first thermoplastic resin
10 second thermoplastic resin
11 second thermoplastic resin layer
12 anchor coating layer

1. A cover material used for a container having a seal part covered with a polyethylene resin, the cover material comprising
a base material and a sealant layer,
the sealant layer having a laminated structure obtained through lamination of a layer of a first thermoplastic resin having adhesiveness with respect to the base material, and a layer of a second thermoplastic resin having adhesiveness with respect to the seal part covered with the polyethylene resin,
thicknesses of the layer of the first thermoplastic resin and the layer of the second thermoplastic resin satisfying: a thickness of the layer of the first thermoplastic resin ≦ a thickness of the layer of the second thermoplastic resin, and
the layer of the second thermoplastic resin having a dispersion structure obtained by dispersing, in the first thermoplastic resin, the second thermoplastic resin that is non-compatible or partially compatible with respect to the first thermoplastic resin such that a ratio l/s of a domain longer diameter l and a domain shorter diameter s of the second thermoplastic resin falls in a range of 1.55≦l/s≦10.

2. The cover material according to claim 1, wherein the base material includes a paper layer, a printing ink layer formed on one surface of the paper layer, and a metallic foil layer laminated on the other surface via an adhesion resin layer.

3. The cover material according to claim 2, wherein an anchor coating layer is interposed between the metallic foil layer and the layer of the first thermoplastic resin.

4. The cover material according to claim 1, wherein the base material includes a paper layer, a printing ink layer formed on one surface of the paper layer, and a light-blocking layer laminated on the other surface via an adhesion resin layer.

5. The cover material according to claim 1, wherein:
the layer of the first thermoplastic resin is formed from at least one type of resin selected from the group consisting of ethylene—acrylic acid copolymers, ethylene—methacrylic acid copolymers, ethylene—acrylic acid—acrylic acid ester terpolymer resins, ethylene—methacrylic acid—acrylic acid ester terpolymer resins, ethylene—acrylic acid—methacrylic acid ester terpolymer resins, ethylene—methacrylic acid—methacrylic acid ester terpolymer resins, ethylene—acrylic acid ester—acid anhydride terpolymer resins, and ethylene—methacrylic acid ester—acid anhydride terpolymer resins; and
the layer of the second thermoplastic resin includes a blend resin containing a low density polyethylene by 60 to 80 wt % as the first thermoplastic resin and a polybutene-1 by 20 to 40 w% as the second thermoplastic resin.

6. The cover material according to claim 1, wherein the layer of the first thermoplastic resin has a tensile breaking strength of 5 to 20 MPa and a tensile break elongation of not larger than 600% in accordance with JIS.K7113.

7. The cover material according to claim 5, wherein an MFR ratio of the low density polyethylene and the polybutene-1 is 1/40 to 3/4.

8. The cover material according to claim 1, wherein the sealant layer is laminated on the base material through co-extrusion lamination.
